(19) United States
(12) Patent Application Publication
(10) Pub. No.: US 2016/0243919 A1
(43) Pub. Date: Aug. 25, 2016

(54) COOLING UNIT FOR VEHICLE BATTERY PACK

(71) Applicant: TOYOTA JIDOSHA KABUSHIKI KAISHA, Toyota-shi (JP)

(72) Inventors: Atsushi YAMANAKA, Okazaki-shi (JP); Tsuyoshi HAYASHI, Miyoshi-shi (JP)

(73) Assignee: TOYOTA JIDOSHA KABUSHIKI KAISHA, Toyota-shi (JP)

(21) Appl. No.: 15/046,955

(22) Filed: Feb. 18, 2016

(30) Foreign Application Priority Data
Feb. 20, 2015 (JP) 2015-031941

(51) Int. Cl. B60H 1/00

(52) U.S. Cl. CPC B60H 1/00278; B60H 1/00328; B60H 1/004

(57) ABSTRACT

A cooling unit for a vehicle battery pack includes a cooling blower configured to blow cooling air to a battery pack mounted on a vehicle, an inlet duct that is connected with the cooling blower and provided with an inlet port opening upwardly, and a cover member arranged above the inlet port. The cover member has a top plate configured to be separated upwardly from an end face of the inlet port and configured to cover the inlet port, and a side plate configured to be separated from a side surface of the inlet port and that extends below an end face of the inlet port from a side edge of the top plate. An opening communicating with the inlet port is formed between the side surface of the inlet port and an inner wall of the side plate.

### INCORPORATION BY REFERENCE

The disclosure of Japanese Patent Application No. 2015-031941 filed on Feb. 20, 2015 including the specification, drawings and abstract is incorporated herein by reference in its entirety.

### BACKGROUND OF THE INVENTION

1. Field of the Invention

The invention relates to a cooling unit for a vehicle battery pack, especially to a cooling unit having an inlet duct provided with an inlet port that is open upwardly.

2. Description of Related Art

A battery pack including a battery for driving a motor is mounted on an automobile and a hybrid vehicle. The battery pack generates heat due to discharge and charge, and, since output characteristics of the battery pack are deteriorated at high temperature, air in a vehicle interior is blown by a cooling blower to the battery pack for cooling.

A battery pack is arranged at various positions in a vehicle, such as underneath a seat, an underfloor space of a floor panel, and a cargo room, depending on a vehicle structure, a size of the battery pack, and so on. Especially, when a battery pack is arranged in an underfloor space of a floor panel, there are instances where a cooling blower is also arranged in the underfloor space. As a structure in which a cooling blower is arranged in an underfloor space, a structure is known, which is provided with an inlet duct having an inlet port in a floor panel, a cooling blower connected with a downstream end of the inlet duct, and a liquid reservoir that is provided in the inlet duct and retains liquid flown into the inlet duct (for example, Japanese Patent Application Publication No. 2014-129039 (JP 2014-129039 A)).

In the structure described in JP 2014-129039 A, since the inlet port is provided in the floor panel, the inlet port is open upwardly. Therefore, in a case where liquid such as beverage is spilled in a vehicle interior, the liquid flows into the inlet duct from the inlet port and the liquid reservoir retains the liquid temporarily.

However, when a large amount of liquid flows in the liquid reservoir in excess of its capacity, the liquid reservoir is not able to retain the liquid, and the liquid reaches the cooling blower. This could cause a malfunction of the cooling blower.

Even though a liquid inflow amount is not so large, the liquid that has flown in is not necessarily retained in the liquid reservoir, and could reach the cooling blower. Moreover, although the liquid reservoir is provided on the way from the inlet port to the cooling blower, in a case where the cooling blower is arranged immediately below the inlet port, it becomes difficult to provide the liquid reservoir. In such a case, when liquid flows in from the inlet port, the liquid directly reaches the cooling blower.

### SUMMARY OF THE INVENTION

Thus, the invention provides a cooling unit that restrains liquid from flowing into an inlet duct and reduces a malfunction of a cooling blower caused by the liquid.

A cooling unit for a vehicle battery pack according to an aspect of the invention is characterized by including a cooling blower configured to blow cooling air to a battery pack mounted on a vehicle, an inlet duct that is connected with the cooling blower and provided with an inlet port opening upwardly, a cover member arranged above the inlet port. The cover member has a top plate configured to be separated upwardly from an end face of the inlet port and configured to cover the inlet port, and a side plate configured to be separated from a side surface of the inlet port and that extends below an end face of the inlet port from a side edge of the top plate, and an opening communicating with the inlet port is formed between the side surface of the inlet port and an inner wall of the side plate. Thus, an intake passage into the inlet port becomes a labyrinth structure, thereby restraining liquid from entering the inlet duct.

The top plate may have a sound absorbing member that absorbs operating noise of the cooling blower.

A cooling unit for a vehicle battery pack according to another aspect of the invention is characterized by including a cooling blower configured to blow cooling air to a battery pack mounted on a vehicle, an inlet duct that is connected with the cooling blower and provided with an inlet port opening upwardly, and a cover member arranged above the inlet port. The cover member is configured to cover the inlet port such that an intake passage to the inlet port becomes a labyrinth structure.

According to the above aspect of the invention, liquid is restrained from flowing into the inlet duct, thereby reducing a malfunction of the cooling blower caused by liquid.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic side view of a hybrid vehicle according to an embodiment of the invention;

FIG. 2 is a perspective view of a cooling unit and an under body;

FIG. 3 is an exploded perspective view of the cooling unit;

FIG. 4 is an exploded perspective view of the cooling blower and a floor panel;

FIG. 5 is an exploded perspective view of the cooling blower and an inlet duct;

FIG. 6 is an enlarged sectional view of the vicinity of an inlet port of the inlet duct;

FIG. 7 is an exploded perspective view of an inlet cover; and

FIG. 8 is an enlarged sectional view of an engagement part of a cover member.

### DETAILED DESCRIPTION OF EMBODIMENTS

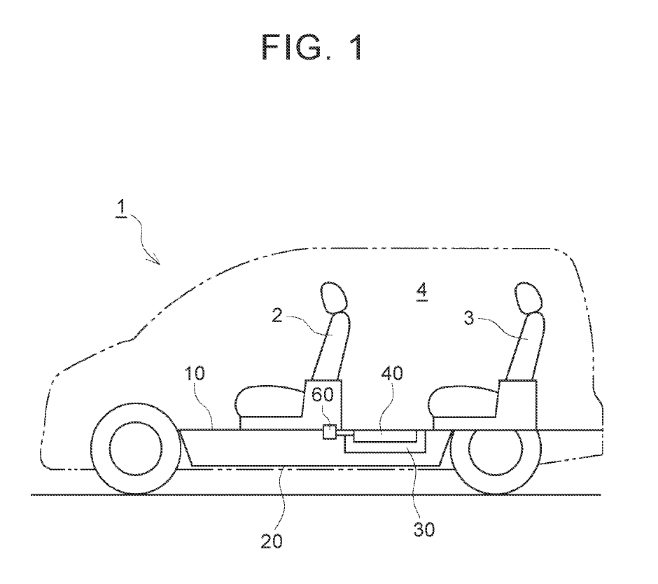

First of all, an arrangement position of a battery pack 30, which includes a battery for supplying electric power to a driving motor for a hybrid vehicle 1, is explained. As shown in FIG. 1, the hybrid vehicle 1 is provided with a vehicle compartment floor panel 10, which structures a floor of a vehicle compartment 4 where a front seat 2 and a rear seat 3 are arranged, and an under body 20 that structures an under floor space of the vehicle compartment 4.

In the underfloor space between the front seat 2 and the rear seat 3, the battery pack 30 for supplying electric power to the driving motor is arranged. The battery pack 30 is arranged on the right side in the vehicle-width direction, and a cooling unit 40, which blows air of the vehicle compartment 4 to the battery pack 30, is arranged at a position adjacent to the battery pack 30 in the vehicle-width direction, namely, on the left side in the vehicle-width direction.

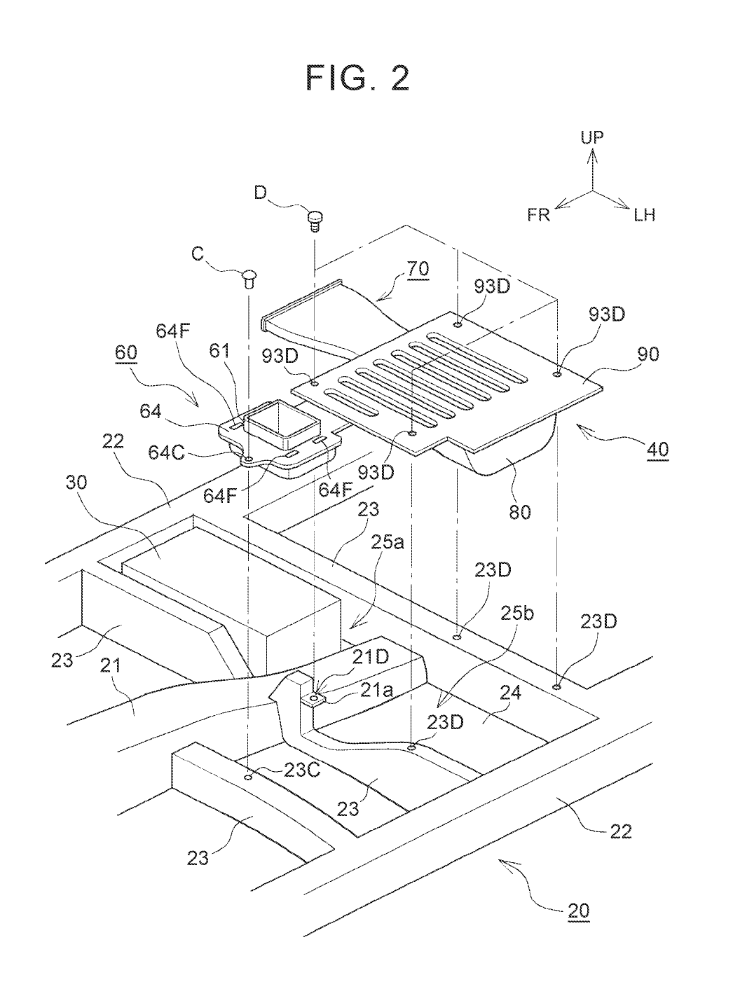

As shown in FIG. 2, the under body 20 is provided with a floor tunnel 21 extending longitudinally in a center in the vehicle-width direction, side sills 22 extending longitudinally on both sides in the vehicle-width direction, cross members 23 extending in the vehicle-width direction, and a bottom panel 24 that is a bottom part of an area surrounded by the floor tunnel 21, the side sills 22, and the cross members 23. In FIG. 2, arrow FR shows a direction in which the vehicle advances, and arrow UP shows a vehicle upper direction, arrow LH shows the left side in the vehicle advancing direction. A relation among arrows FR, UP, LH is the same in the other drawings.

In the under body 20, two recessed portions 25a, 25b are formed, which are surrounded by the floor tunnel 21, the side sills 22, the cross members 23, and the bottom panel 24. The recessed portions 25a, 25b are positioned between the front seat 2 and the rear seat 3.

The battery pack 30 is housed in the recessed portion 25a. The cooling unit 40 is housed in the recessed portion 25b so that an air-blowing port faces the battery pack 30. As stated later, the housed cooling unit 40 includes a cooling blower 50 that discharges cooling air, an inlet duct 60 that takes in air of the vehicle interior, and a cooling duct 70 that leads the cooling air to the battery pack 30, and the cooling blower 50, the inlet duct 60 and the cooling duct 70 are suspended from and fixed to a floor panel 90 that forms a part of the vehicle compartment floor panel 10.

The floor panel 90 is provided with four mounting holes 93D for mounting the floor panel 90 onto the cross members 23 of the under body 20. As stated above, the floor panel 90, to which the cooling blower 50, the inlet duct 60, and the cooling duct 70 are fixed, is fixed to the cross members 23 by four bolts D through the four mounting holes 93D. An end part of the inlet duct 60 is provided with a mounting hole 64C for mounting the inlet duct 60 onto the cross member 23 of the under body 20. Then, the inlet duct 60 is fixed to the cross member 23 by a clip C through the mounting hole 64C.

The cross members 23 are provided with screw holes 23D, which corresponds to the bolts D for fixing the floor panel 90, and a fixing hole 23C, which corresponds to the clip C for fixing the inlet duct 60. Also, the floor tunnel 21 is provided with a bracket 21a having a screw hole 21D that corresponds to the bolt D for fixing the floor panel 90.

An upper part of the battery pack 30 is covered by another floor panel (not shown) mounted on the cross members 23. This floor panel also covers an upper part of the cooling duct 70 of the cooling unit 40. The floor panel 90 of the cooling unit 40 and another floor panel covering the upper part of the battery pack 30 structure a part of the vehicle compartment floor panel 10 of the vehicle compartment 4.

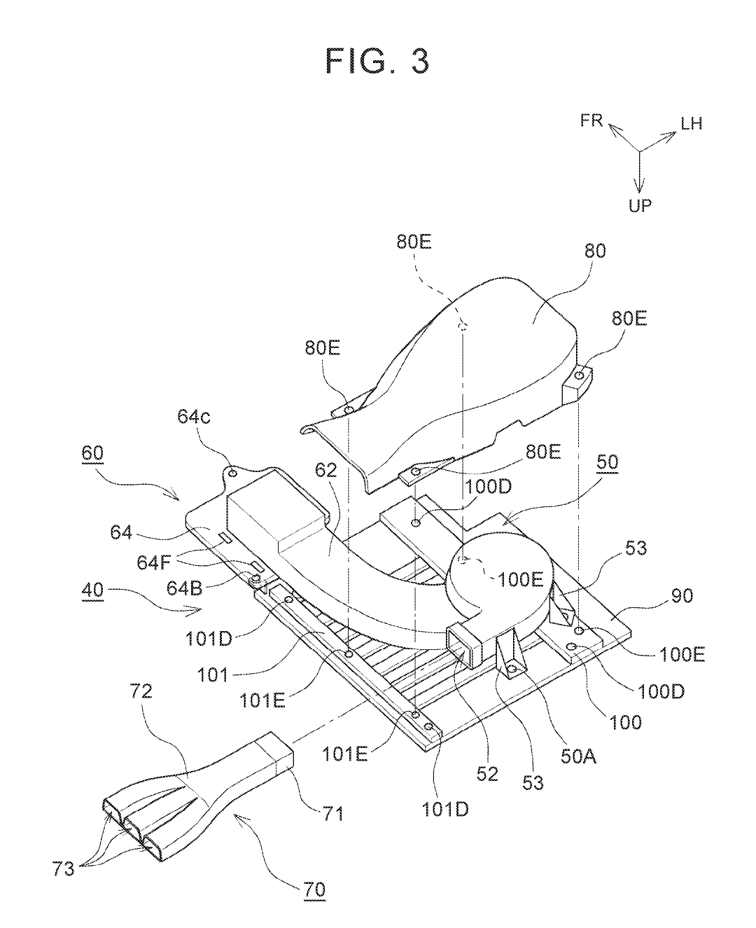

Next, the cooling unit 40 is explained with reference to FIG. 3 to FIG. 5. In FIG. 3 to FIG. 5, the cooling unit 40 shown in FIG. 2 is turned upside down. This means that FIG. 3 to FIG. 5 show the cooling unit 40 seen from below.

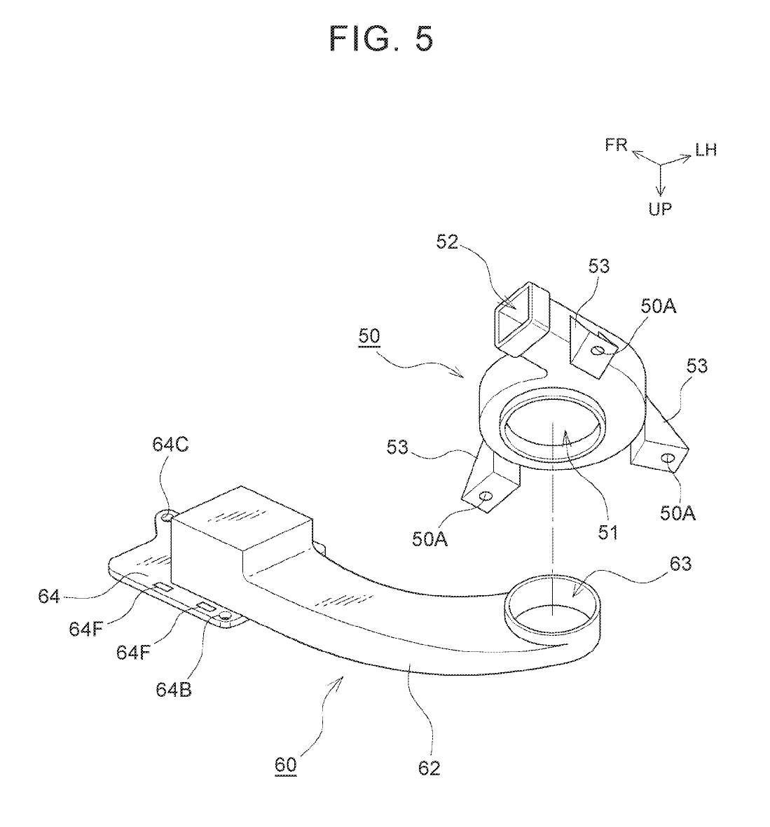

As shown in FIG. 3, the cooling blower 50, the inlet duct 60, and the cooling duct 70 that structure the cooling unit 40 are suspended from a lower surface of the floor panel 90. Skeleton members 100, 101 for reinforcement of the floor panel 90 are fixed to the lower surface of the floor panel 90, and the cooling blower 50 is fixed to one of the skeleton members 100. The skeleton member 100 is firmly fixed to the lower surface of the floor panel 90, and holds and fixes the cooling blower 50 so as to be able to cope with vibration and so on. Further, the inlet duct 60 is combined with an inlet port 51 of the cooling blower 50, and the inlet duct 60 is able to lead air in the vehicle interior to the cooling blower 50 (see FIG. 5). Meanwhile, a connection port 71 of the cooling duct 70 is fitted to a discharge port 52 of the cooling blower 50, and cooling air discharged from the cooling blower 50 is lead to the battery pack 30 by the cooling duct 70.

Water is prevented by a waterproof tray 80 from entering the cooling blower 50 from outside, and the waterproof tray 80 is also held by and fixed to the skeleton members 100, 101. The waterproof tray 80 is structured from a resin, and provided with mounting holes 80E at four corners of the waterproof tray 80 for fixing the waterproof tray 80 to the skeleton members 100, 101. Further, the skeleton members 100, 101 are provided with mounting holes 100E, 101E, respectively, corresponding to positions of the mounting holes 80E.

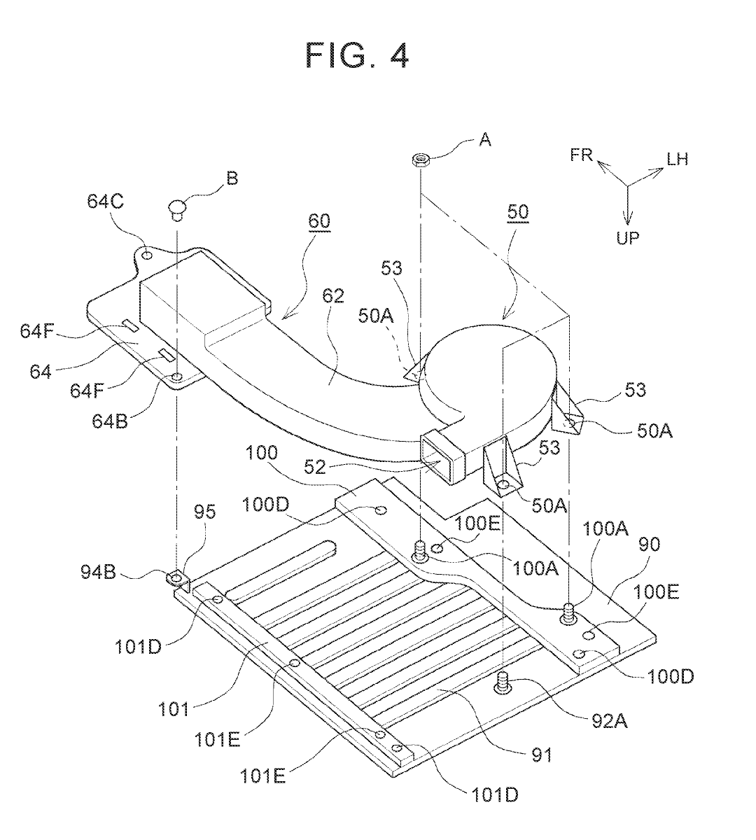

As shown in FIG. 4, the cooling blower 50 and the inlet duct 60 are fixed to the lower surface of the floor panel 90 to which the skeleton members 100, 101 are fixed. The skeleton member 100 is provided with two stud bolts 100A for fixing the cooling blower 50, and the lower surface of the floor panel 90 is also provided with one stud bolt 92A for fixing the cooling blower 50. Corresponding to the stud bolts 92A, 100A, the cooling blower 50 has mounting holes 50A for fixing the cooling blower 50, and is fixed to the stud bolts 92A, 100A by nuts A.

The lower surface of the floor panel 90 is provided with a bracket 95 having a clip fixing hole 94B for fixing the inlet duct 60. Corresponding to the clip fixing hole 94B, the inlet duct 60 is provided with a mounting hole 64B for fixing the inlet duct 60, and the inlet duct 60 is fixed to the bracket 95 of the floor panel 90 by a clip B.

The floor panel 90 is structured from thin sheet metal in which a plurality of beads 91 extending in the vehicle-width direction are formed, and has a shape that covers the recessed portion 25b. The skeleton members 100, 101 fixed to the floor panel 90 are arranged on both ends of the floor panel 90 in a direction orthogonal to the beads 91.

The skeleton member 100 is provided with mounting holes 100D for mounting the skeleton member 100 onto the cross members 23 of the under body 20. Meanwhile, the skeleton member 101 is also provided with mounting holes 101D for mounting the skeleton member 101 on the cross members 23 of the under body 20. The mounting holes 100D, 101D are arranged at positions corresponding to the mounting holes 93D of the floor panel 90. Therefore, the skeleton members 100, 101 are fixed to the cross members 23 together with the floor panel 90 by the bolts D (see FIG. 2).

The skeleton members 100, 101 are made from metal plates having a given thickness. The skeleton members 100, 101 may also be formed by bending sheet metal. Since the skeleton members 100, 101 reinforce the floor panel 90, the skeleton members 100, 101 are required to have desired rigidity. In particular, since the cooling blower 50 is fixed to the skeleton member 100, the skeleton member 100 is required to have rigidity that withstands vibration of the cooling blower 50. Thus, fixing positions, shapes, and materials for the skeleton members 100, 101 are set so that the skeleton members 100, 101 are rigid enough to reinforce the floor panel 90 and also withstand vibration of the cooling blower 50. In this embodiment, the skeleton member 100, on which the cooling blower 50 is mounted, has a wide shape.

As shown in FIG. 4 and FIG. 5, the cooling blower 50 is a sirocco fan including the inlet port 51 that takes in air from a center part of a rotary fan (not shown) in a rotation axis direction, and a discharge port 52 that discharges air in a radial direction of the rotation axis. The cooling blower 50 is provided with three legs 53 having the mounting holes 50A for mounting the cooling blower 50 onto the floor panel 90 and the skeleton member 100. A power cable (not shown) is connected with the cooling blower 50.

As shown in FIG. 2 to FIG. 7, the inlet duct 60 is connected with the inlet port 51 of the cooling blower 50. The inlet duct 60 is provided with an quadrangular inlet port 61 opening to the vehicle compartment 4, a curved duct 62 continuous from the inlet port 61, a connection port 63 connected with the inlet port 51 of the cooling blower 50, and a cover member 65 that covers the inlet port 61. The inlet duct 60 and the cooling blower 50 are fixed to each other by clips (not shown) in a state where the connection port 63 and the inlet port 51 are combined with each other.

A flange 64 is provided around the inlet port 61, and the flange 64 is provided with a mounting hole 64B (see FIG. 4) for mounting the flange 64 onto the floor panel 90, a mounting hole 64C for mounting the flange 64 to the cross member 23, and mounting holes 64F for mounting the cover member 65.

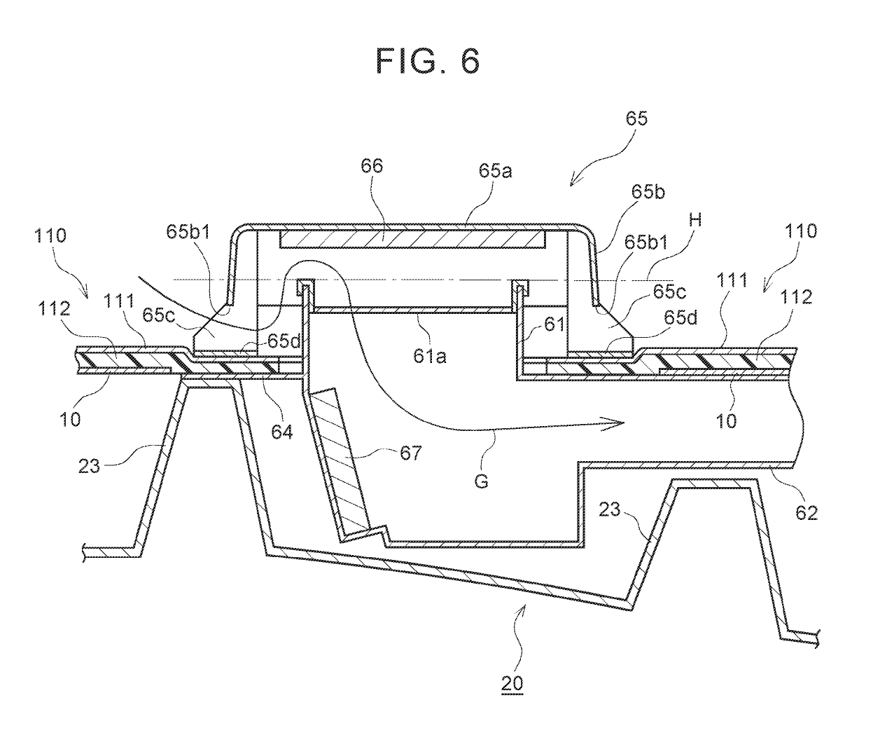

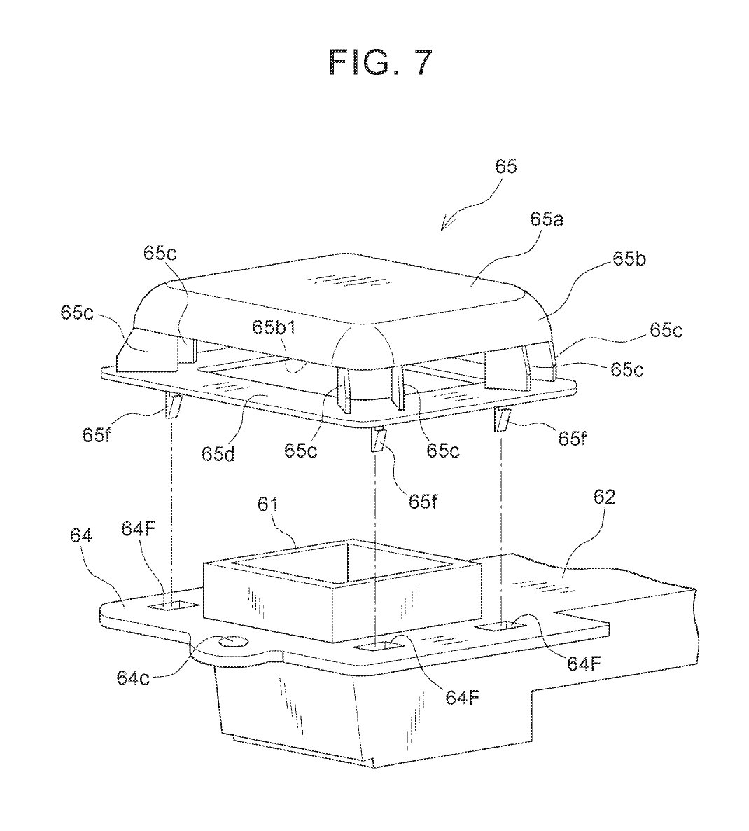

As shown in FIG. 6 and FIG. 7, the open box-shaped cover member 65 corresponding to the quadrangular inlet port 61 is arranged above the inlet port 61. The cover member 65 is provided with a top plate 65a that covers the inlet port 61, a side plate 65b formed continuously from the periphery of the top plate 65a, pairs of leg portions 65c extending downwardly from four corners of the top plate 65a, respectively, a quadrilateral annular-shaped flange 65d that connects lower ends of the leg portions 65c with each other, and engaging pawls 65f projecting downwardly from a lower surface of the flange 65d.

The top plate 65a is arranged above and separated from an opening end face H of the inlet port 61. A lower end 65b1 of the side plate 65b extends below the opening end face H of the inlet port 61, and covers the inlet port 61 so as to surround the periphery of the inlet port 61. Therefore, there is an opening between the lower end 65b1 of the side plate 65b and the flange 65d, thereby forming an opening communicating with the inlet port 61 between a side surface of the inlet port 61 and an inner surface (an inner wall) of the side plate 65b. Then, an intake passage to the inlet port 61 has a passage structure that goes over the inlet port 61 once from below the lower end 65b1 of the side plate 65b and goes inside the inlet port 61, and the structure of the intake passage to the inlet port 61 is a labyrinth structure. The labyrinth structure is a structure in which the intake passage to the inlet port 61 has a vertical zigzag configuration, and is a structure that restrains liquid from entering the inlet port 61.

A sound absorbing member 66, which absorbs operating noise of the cooling blower 50, is provided on an inner side of the top plate 65a. Noise is absorbed most when it is incident perpendicularly to the sound absorbing member 66. Therefore, by providing the sound absorbing member 66 in a part facing the inlet port 61, it is possible to optimize sound-absorbing efficiency. Also, a sound absorbing member 67 is provided on an inner side surface near the inlet port 61 of the inlet duct 60. The sound absorbing members 66, 67 are structured from, for example, inorganic fiber such as glass wool, metallic fiber made of aluminum and so on, synthetic resin foam made from polyethylene resin and so on.

As shown in FIG. 6, the vehicle compartment floor panel 10 around the inlet port 61 is covered by a floor carpet 110. The floor carpet 110 is provided with an opening corresponding to the inlet port 61, and the floor carpet 110 includes two layers, namely, a surface layer 111 on the vehicle compartment 4 side, and a felt layer 112 that forms a back layer on the vehicle compartment floor panel 10 side. The floor carpet 110 is fixed to the vehicle compartment floor panel 10 by fixing means such as a clip.

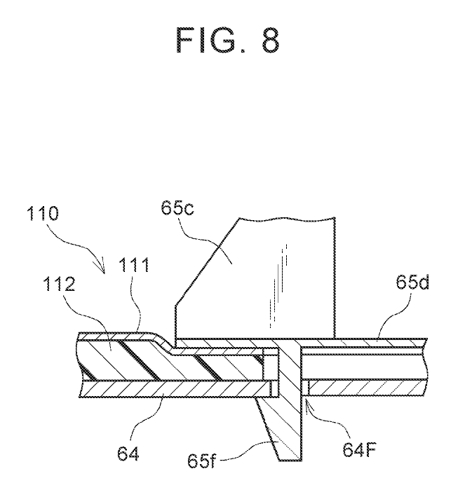

As shown in FIG. 7 and FIG. 8, the engaging pawls 65f have tapered tips and are formed from elastic members. The engaging pawls 65f are provided at positions in the flange 65d corresponding to the mounting holes 64F of the flange 64, respectively, and are engaged with the mounting holes 64F. The positions where the engaging pawls 65f are engaged with the mounting holes 64F are set to positions at which the felt layer 112 of the floor carpet 110 is crushed and compressed when the floor carpet 110 is sandwiched between the flange 64 and the flange 65d. In other words, when the engaging pawls 65f are engaged with the mounting holes 64F while crushing the felt layer 112 of the floor carpet 110, the floor carpet 110 is sandwiched between the flange 64 and the flange 65d and fixed. Therefore, since the floor carpet 110 is crushed and sandwiched between the flange 64 and the flange 65d around the inlet port 61, the periphery of the inlet port 61 is sealed.

Also, a dustproof filter 61a is mounted on the inlet port 61 in a detachable fashion for restraining foreign matters from entering the inlet port 61, and the dustproof filter 61a is replaceable. Since the cover member 65 is able to be detached by using the engaging pawls 65f, maintenance such as cleaning, and exchange of dustproof filter 61a are easily performed.

The cooling duct 70 is explained with reference to FIG. 3. As shown in FIG. 3, the cooling duct 70 is provided with the connection port 71 fitted to the discharge port 52 of the cooling blower 50, a duct 72 widening towards a downstream continuously from the connection port 71, and exhaust ports 73 that are duct ends discharging air to the battery pack 30.

Next, assembling and mounting of the cooling unit 40 onto the under body 20 are explained. First of all, as shown in FIG. 5, the connection port 63 of the inlet duct 60 is combined with the inlet port 51 of the cooling blower 50, and the cooling blower 50 and the inlet duct 60 are fixed to each other by clips (not shown).

Then, as shown in FIG. 4, the skeleton members 100, 101 are mounted and fixed to the lower surface of the floor panel 90 by bolts (not shown). The stud bolts 100A of the skeleton member 100 and the stud bolt 92A of the floor panel 90 are inserted through the mounting holes 50A of the legs 53 of the cooling blower 50, to which the inlet duct 60 is fixed, and are fastened by the nuts A. Thus, the cooling blower 50 is fixed to the skeleton member 100 and the floor panel 90. By inserting the clip B through the mounting hole 64B of the inlet duct 60 and mounting the clip B onto the clip fixing hole 94B of the floor panel 90, the flange 64 of the inlet duct 60 is fixed to the floor panel 90.

Further, as shown in FIG. 3, the connection port 71 of the cooling duct 70 is fitted to the discharge port 52 of the cooling blower 50. Further, clips (not shown) are inserted into the mounting holes 80E of the waterproof tray 80 and the mounting holes 100E, 101E of the skeleton members 100, 101, thereby mounting the waterproof tray 80 onto the skeleton members 100, 101. In this way, the cooling unit 40 is assembled.

As shown in FIG. 2, the assembled cooling unit 40 is housed in the recessed portion 25b of the under body 20 in which the battery pack 30 is housed. Thereafter, a mounting position of the cooling unit 40 is adjusted, and then the cooling unit 40 is fixed by the bolts D.

After the cooling unit 40 is mounted, the floor panel 90 is covered by the floor carpet 110, and the floor carpet 110 is fixed to the vehicle compartment floor panel 10 by fixing means such as a clip. Then, the engaging pawls 65f of the cover member 65 are engaged with the mounting holes 64F of the flange 64 so that the floor carpet 110 is sandwiched between the flange 65d of the cover member 65 and the flange 64. Due to the engagement, the floor carpet 110 is crushed by the flange 65d and the flange 64 and fixed. As the cover member 65 is mounted on the flange 64, an upper part and periphery of the inlet port 61 are covered.

After the rest of the components (not shown) and the floor carpet 110 are mounted, and the cooling blower 50 is driven, air in the vehicle compartment 4 goes over the inlet port 61 once from below the lower end 65b1 of the side plate 65b and is sucked inside the inlet port 61 as shown by arrow G in FIG. 6, and discharged from the exhaust ports 73. Air discharged from the exhaust ports 73 is blown to the battery pack 30, cools the battery pack 30, and then is discharged inside the under body 20.

As stated so far, the lower end 65b1 of the side plate 65b extends below the opening end face H of the inlet port 61, and covers the inlet port 61 so as to surround the periphery of the inlet port 61. Therefore, the intake passage into the inlet duct 60 is a passage that goes over the inlet port 61 once from below the lower end 65b1 of the side plate 65b and goes into the inlet port 61, and the structure of the intake passage is a labyrinth structure. Therefore, even though a large amount of liquid is spilled inside the vehicle compartment 4, the liquid is restrained from entering from the inlet port 61 because an upper part of the inlet port 61 is covered by the cover member 65.

Further, even though liquid flows around the inlet port 61, the liquid is restrained from entering because the inlet port 61 is positioned above the floor carpet 110 and has a labyrinth structure. Therefore, the liquid is also restrained from entering into the cooling blower 50, thereby reducing a malfunction of the cooling blower 50 caused by liquid.

Further, because of the labyrinth structure, a bar-like foreign matter is restrained from entering the inlet port 61, thereby preventing damage of the dustproof filter 61a. By restraining liquid from entering the inlet port 61, liquid is also restrained from entering the cooling blower 50 even if, for example, the cooling blower 50 is arranged immediately below the inlet port 61. The sound absorbing member 66 is provided in a part of the cover member 65, which faces the inlet port 61. This means that the sound absorbing member 66 is provided in a part with the best sound-absorbing efficiency. Therefore, it is possible to absorb noise of the cooling blower 50 effectively.

When exhaust pressure of the cooling blower 50 is high, there are instances where air with increased temperature after cooling the battery pack 30 moves around into the under body 20 and is flown out to the vicinity of the inlet port 61 from a gap between the inlet port 61 and the floor carpet 110. When the air with increased temperature is sucked in from the inlet port 61, efficiency of cooling the battery pack 30 can be deteriorated.

However, in the foregoing embodiment, since the floor carpet 110 in the periphery of the inlet port 61 is crushed and sandwiched between the flanges 64, 65d, the periphery of the inlet port 61 is sealed, thereby improving seal performance. Thus, air with increased temperature is restrained from leaking out from the periphery of the inlet port 61. Hence, air with increased temperature leaking out from the periphery is restrained from being sucked in from the inlet port 61, thereby preventing deterioration of efficiency of cooling the battery pack 30. Further, due to improvement of seal performance of the periphery of the inlet port 61, it is possible to reduce leakage of noise from below the vehicle compartment floor panel 10. Furthermore, even though there is a manufacturing error in the thickness of the floor carpet 110, the manufacturing error is absorbed because the floor carpet 110 is sandwiched and compressed.

Since the cooling blower 50 is fixed to the lower surface of the floor panel 90, the cooling blower 50 is in a state of being suspended from the floor panel 90, namely, in a state of being arranged above the recessed portion 25b. Therefore, even though under body 20 is inundated with water, it is possible to restrain water from inundating the cooling blower 50. Further, since the cooling blower 50 is covered by the waterproof tray 80, it is possible to further restrain inundation of the cooling blower 50.

The cooling blower 50 is fixed directly to the skeleton member 100 having rigidity that withstands vibration of the cooling blower 50. Therefore, even though the cooling blower 50 vibrates while the cooling blower is operating, the vibration is not transmitted easily to the floor panel 90, the inlet duct 60, and the cooling duct 70, and it is thus possible to restrain noise caused by transmission of vibration of the cooling blower 50. Further, since the skeleton member 100 is fixed to the under body 20, rigidity of the skeleton member 100 is increased, thereby further restraining noise caused by transmission of vibration of the cooling blower 50.

In this embodiment, since the floor panel 90 is reinforced by the skeleton members 100, 101, the floor panel 90 has rigidity that does now allow the floor panel 90 to be deformed even if an occupant rides on it, and, as shown in FIG. 1, it is thus possible to arrange the cooling unit 40 in a part where ingresses and egresses of an occupant happens. Also, an influence of a load of ingresses and egresses on the cooling unit 40 is restrained. By providing the beads 91 in the floor panel 90, it is possible to further improve rigidity of the floor panel 90.

In the foregoing embodiment, there is an opening between the lower end 65b1 of the side plate 65b of the cover member 65 and the flange 65d. However, the lower end 65b1 of the side plate 65b may extend until the flange 65d and the side plate 65b and the flange 65d may be integrated with each other. In this case, a plurality of slits are provided in the side plate 65b, and air in the vehicle interior is sucked in from the slits, and then sucked into the inlet port 61 through a space between a side surface of the inlet port 61 and an inner surface of the side plate 65b.

With such a structure, the leg portions 65c of the cover member 65 are no longer necessary, and the shape of the cover member 65 is simplified. Thus, foreign matters are restrained from entering the inlet port 61 even more.

In the foregoing embodiment, the engaging pawls 65f are used as structures for mounting the cover member 65 onto the flange 64. Instead of the structures, fastening means such as stud bolts may be used. The case was explained in which the cooling unit 40 is arranged in an underfloor space of the floor panel 90. However, even in a case where the cooling unit 40 is arranged under a seat, in a cargo room, and so on, it is still possible to apply the cover member 65 to the inlet port 61. It is particularly effective when the inlet port 61 is exposed in the vehicle compartment 4 because the cover member 65 protects the inlet port 61.

What is claimed is:

1. A cooling unit for a vehicle battery pack comprising:
a cooling blower configured to blow cooling air to a battery pack mounted on a vehicle;
an inlet duct that is connected with the cooling blower and provided with an inlet port opening upwardly; and
a cover member arranged above the inlet port, wherein
the cover member has a top plate configured to be separated upwardly from an end face of the inlet port and configured to cover the inlet port, and a side plate configured to be separated from a side surface of the inlet port, and the side plate extending below an end face of the inlet port from a side edge of the top plate, and
an opening communicating with the inlet port is formed between the side surface of the inlet port and an inner wall of the side plate.

2. The cooling unit for a vehicle battery pack according to claim 1, wherein the top plate has a sound absorbing member configured to absorb operating noise of the cooling blower.

3. A cooling unit for a vehicle battery pack comprising:
a cooling blower configured to blow cooling air to a battery pack mounted on a vehicle;
an inlet duct that is connected with the cooling blower and provided with an inlet port opening upwardly; and
a cover member arranged above the inlet port, wherein
the cover member configured to cover the inlet port such that an intake passage to the inlet port becomes a labyrinth structure.
